(19) United States
(12) Patent Application Publication
(10) Pub. No.: US 2025/0367634 A1
(43) Pub. Date: Dec. 4, 2025

(54) SURFACTANT-MODIFIED MONTMORILLONITE FOR ADSORPTION OF PER- AND POLYFLUOROALKYL SUBSTANCES (PFAS) FROM AQUEOUS SOLUTIONS

(71) Applicant: The Research Foundation for the State University of New York, Albany, NY (US)

(72) Inventors: Yanna Liang, Albany, NY (US); Tao Jiang, Albany, NY (US); Weilan Zhang, Albany, NY (US)

(21) Appl. No.: 19/107,974

(22) PCT Filed: Aug. 25, 2023
(86) PCT No.: PCT/US2023/031130

§ 371 Date: Feb. 28, 2025

Related U.S. Application Data
(60) Provisional application No. 63/402,993, filed on Sep. 1, 2022.

(51) Int. Cl. B01J 20/12; B01J 20/22; B01J 20/30; C02F 1/28; C02F 101/36

(52) U.S. Cl. CPC B01J 20/12; B01J 20/22; B01J 20/3071; B01J 20/3078; B01J 20/3085; C02F 1/288; C02F 1/281; C02F 1/285; C02F 2101/36; C02F 2305/04

(57) ABSTRACT

A montmorillonite, preferably MT K10, modified with at least cetyltrimethyl ammonium chloride (CTAC), a cationic quaternary ammonium compound, such that the combined compound is adsorbent of short- and long-chain per- and polyfluoroalkyl substances (PFAS) and precursors. The MT-CTAC compound is particularly suited to remove PFAS from aqueous solutions. The MT-CTAC compound is produced by adding a predetermined amount of montmorillonite to a Na₂CO₃ solution, stirring the solution for a predetermined duration, drying the solution to form solid Na-MT, adding the dried Na-MT to a predetermined solution of CTAC, stirring the Na-MT-CTAC solution for a predetermined duration to create a MT-CTAC compound, and then drying the MT-CTAC compound for a predetermined duration.

### CROSS-REFERENCE TO RELATED APPLICATION

This application claims the benefit of U.S. Provisional Application No. 63/402,993, filed Sep. 1, 2022, the entirety of which is hereby incorporated herein by this reference.

### BACKGROUND OF THE INVENTION

### 1. Field of the Invention

The present invention generally relates to clay-based adsorbents. More particularly, the present invention relates to modification of montmorillonite by a cationic surfactant for adsorption of mixed short and long chain per- and polyfluoroalkyl substances (PFAS) and precursors from an aqueous solution.

### 2. Description of the Related Art

Per- and polyfluoroalkyl substances (PFAS) are a group of chemicals consisting of thousands of synthetic organic compounds in which the hydrogen atoms bound to the carbon backbones are fully or partially substituted with fluorine. The unique properties of PFAS have enabled their great use in numerous industrial processes and commercial products, including mining and oil well surfactants, coatings for textiles and food packaging, firefighting foams, cosmetics and personal care, cleaning agents, and many others. The wide usage of PFAS has resulted in their broad distribution and possible adverse effects in the environment. They have been reported to occur in various environmental matrices, such as surface waters, rainwater, ground water, indoor and outdoor air, household dust, sediments, sewage sludge, and soil.

PFAS have been manufactured for over sixty years and because they are now detected ubiquitously, PFAS attract growing concerns due to the risks to human health and the environment associated with their presence, frequency of occurrence, and sources of contamination. PFAS can be bioaccumulative in the environment and also undergo biomagnification. PFAS have been identified as persistent organic pollutants (POPs) with estimated half-lives of up to 8.5 years, with detection in blood sera of a wide variety of living creatures, such as humans, cattle, minks, otters, marine mammals, birds, fish, and mussels. Various studies have demonstrated acute, subacute, subchronic, chronic, and developmental toxicities of PFAS to animals. Recently, the U.S. EPA dramatically lowered the lifetime health advisory levels in drinking water for the two legacy PFAS in the U.S.—perfluorooctanoic acid (PFOA) and perfluorooctanesulfonic acid (PFOS), from the previous 70 parts per trillion (ppt) to 0.004 ppt for PFOA and 0.02 ppt for PFOS (USEPA 2022). Additionally, the EPA issued final health advisories for two PFOA and PFOS alternatives, namely undecafluoro-2-methyl-3-oxahexanoic acid (GenX) and perfluorobutane sulfonic acid (PFBS), in drinking water (USEPA 2022). Therefore, it is a critical and urgent task to remediate PFAS from the environment.

Due to the remarkably high energy of carbon-fluorine bonds (the strongest existing covalent bond with 450 KJ/mol), PFAS are resistant to thermal, chemical, and biological decomposition, leading to their extreme stability and persistence. Thus, destruction of PFAS is extraordinarily difficult as it requires intensive energy consumption and extant efforts of PFAS destruction are often ineffective. Moreover, conventional water and wastewater treatment processes, such as coagulation, flocculation, sedimentation, and filtration, have been demonstrated to be ineffective for PFAS removal from aqueous sources.

Adsorption has been one effective method to remove PFAS contamination from water, sludge, and soil. Known PFAS adsorbents include carbon-based materials, ion exchange resins, biosorbents, and clay-based materials. Activated carbon (AC) including granular and powdered AC (GAC and PAC), carbon nanotubes (CNTs), and biochars are the main carbon-based materials for PFAS adsorption, of which AC and CNTs showed high adsorption capacity. The non-polar functional groups of carbon-based adsorbents contribute to the hydrophobic PFAS adsorption. However, carbon-based materials have encountered two critical issues in use for PFAS adsorption, namely slow adsorption kinetics and much lower efficiency in removing short-chain PFAS than long-chain ones. Furthermore, it has been unclear as to whether those materials are able to retain PFAS precursors, which are attracting increasing concerns, in aqueous solution. The overall process of producing carbon-based materials is highly energy intensive and has drawn scrutiny and attention recently in terms of greenhouse gas emissions. Compared to carbon-based materials, ion exchange resins are less cost-effective and biosorbents exhibit lower adsorption capacity.

Clay-based materials are another category of PFAS adsorbents. A variety of natural clays has been studied for PFAS adsorption, such as montmorillonite, kaolinite, boehmite, hematite, and alumina. However, natural clays have hydrophilic surfaces due to the hydration of inorganic cations on the exchange sites, leading to the negative charge and thus low effectiveness for adsorption of hydrophobic and anionic PFAS. Consequently, conversion of the hydrophilic surface to a lipophilic one by modifying natural clays with surfactants is a strategy for enhancing PFAS adsorption. After modification, the hydrophobic alkyl chains of surfactants enhance PFAS adsorption via hydrophobic partitioning. Moreover, the positively charged surfaces generated from modification by cationic surfactants have an affinity to anionic PFAS through electrostatic interaction. Several commercial clay-based PFAS adsorbents have been available on the market, such as FLUORO-SORB® and matCARE®.

As a member of the smectite group, the clay montmorillonite (MT) has a structure of two tetrahedral silicate layers sandwiching an aluminum oxide/hydroxide layer in the same stacking (2:1 layered structure), which possesses a high cation exchange capacity (CEC) and specific surface area. Montmorillonite K10 (MT K10) (Al₂H₂O₁₂Si₄) has many applications in synthetic organic reactions due to its properties of low cost, ease of handling, non-corrosiveness, suitable surface area (250 m²/g), and reusability.

Attempts have been made to modify MT with quaternary ammonium compounds to thereby modify its intrinsically hydrophilic surface for enhancing PFAS adsorption. For example, MT has been previously modified with a cationic surfactant hexadecyltrimethylammonium bromide (HDTMAB) to improve PFAS adsorption in aqueous solution, which has achieved the adsorption capacity of approximately 62 and 339 mg/g for PFOA and PFOS, respectively, for the modified clay with HDTMAB/CEC of 0.5. Another known modification of MT was with quaternary ammonium compounds L-carnitine and choline, and the adsorption of PFOA, PFOS, GenX, and PFBS was largely enhanced as compared to original MT. However, these attempts to create a robust, versatile, and inexpensive adsorbent that is capable of adsorbing all types of PFAS have not been practical or commercially viable. It is accordingly to the creation of such a practical and commercially viable MT adsorbent with broad PFAS adsorption that the present invention is primarily directed.

### BRIEF SUMMARY OF THE INVENTION

Briefly described, the present invention is a montmorillonite, preferably MT K10, mixed with at least cetyltrimethyl ammonium chloride (CTAC), a cationic quaternary ammonium compound, such that the combined compound is adsorbent of short- and long-chain per- and polyfluoroalkyl substances (PFAS) and precursors. The MT-CTAC compound is particularly suited to remove PFAS from aqueous solutions.

The invention includes an MT-CTAC compound that is produced by adding a predetermined amount of montmorillonite (such as MT K10) to a Na₂CO₃ solution, stirring the solution for a predetermined duration, drying the solution to form solid Na-MT, adding the dried Na-MT to a predetermined solution of CTAC, stirring the Na-MT-CTAC solution for a predetermined duration to create a MT-CTAC compound, and drying the MT-CTAC compound for a predetermined duration.

The invention also includes a method of removing PFAS from an aqueous solution with the steps of combining montmorillonite and at least a cationic quaternary ammonium chloride (CTAC) to create a PFAS adsorbent compound (MT-CTAC), and then contacting the MT-CTAC with an aqueous solution containing PFAS for a predetermined duration to thereby remove at least some of the PFAS from the aqueous solution.

The present invention is therefore advantageous as it can effectively remove PFAS from aqueous solutions, such as water. Furthermore, the present invention provides a robust, versatile, practical, and inexpensive adsorbent that is capable of adsorbing all types of short and long chain and PFAS.

### BRIEF DESCRIPTION OF THE DRAWINGS

FIG. 1 is a table of the initial pH and concentrations of each PFAS and precursor (C₀, ppb) at each level of mixtures in adsorption kinetics and isotherms experiments.

FIG. 2 is 3D conformers of methylene blue and rose bengal molecules.

FIG. 3 is a graph illustrating the calibration curves between the concentrations and absorbance at 662 and 564 nm for methylene blue and rose bengal, respectively.

FIG. 4. is graphs illustrating the adsorption (removal efficiency) of methylene blue and rose bengal by the unmodified (Na-MT) and three modified clays (MT-CTAC_{0.34}, MT-CTAC_{0.85}, and MT-CTAC_{3.39}) with co-existence of PFAS.

FIGS. 5A-5H are graphs illustrating adsorption of PFAS and precursors by the unmodified (Na-MT) and three modified (MT-CTAC_{0.34}, MT-CTAC_{0.85}, and MT-CTAC_{3.39}) clays with co-exposure of the organic dye.

FIGS. 6A-6C are graphs illustrating the adsorption kinetics of PFAS at different initial concentrations for MT-CTAC_{0.85}.

FIGS. 7A-7D are graphs illustrating the removal efficiency of PFAS and precursors at different initial concentrations and different contacting times (1, 2, 4, 8, 12, and 24 h) for Mt-CTAC_{0.85}.

FIGS. 8A-8D are graphs illustrating the relationship between initial concentrations (C₀) and mass of PFAS and precursors adsorbed by MT-CTAC_{0.85}.

FIG. 9 is a graph illustrating adsorption isotherms of total PFAS and precursors for Mt-CTAC_{0.85}, plotted with Langmuir, Freundlich, and Sips models.

FIGS. 10A-10D are graphs illustrating the adsorption performance comparison among Na-MT, MT-CTAC_{0.85}, and other adsorbents FILTRASORB® 400 GAC, PAC, and an ALA1/clay-based for PFAS at different contacting times (4, 8, and 48 h).

FIG. 11 is a SEM picture of morphological (A, B) and compositional (C, D) analyses of Na-MT (A, C) and Mt-CTAC_{0.85} (B, D) by SEM-EDS, with corresponding graphs illustrating the elemental compositions are shown with normalized concentrations (wt %) and standard deviations (SD).

FIG. 12 is graphs illustrating (A) surface area and pore volume of Na-MT and MT-CTAC_{0.85} analyzed by BET, and (B) the relationship between zeta potential and pH for Na-MT and MT-CTAC_{0.85}.

### DETAILED DESCRIPTION

The present invention is a synthesized novel adsorbent produced through modification of montmorillonite, preferably MT K10, which is extensively used as environmentally benign catalysts for organic reactions, by a cationic quaternary ammonium compound—cetyltrimethyl ammonium chloride (CTAC). The adsorbent has been tested and characterized by analytical instruments. In testing the new compound for PFAS adsorption, the PFAS mixture for adsorption experiments consisted of ten PFAS with high occurrence in the environment, including six perfluorocarboxylic acids (PFCAs) with a carbon chain length from 6 to 11 (i.e., perfluorohexanoic acid (PFHxA), perfluoroheptanoic acid (PFHpA), PFOA, perfluorononanoic acid (PFNA), perfluorodecanoic acid (PFDA), perfluoroundecanoic acid (PFUnA)), three perfluorosulfonic acids (PFSAs) with a carbon chain length from 4 to 8 (i.e., perfluorobutane sulfonate (PFBS), perfluorohexane sulfonate (PFHxS), PFOS), and GenX. Three frequently detected PFAS precursors in the environment, i.e., 6:2 Fluorotelomer sulfonic acid (6:2 FTSA), 2-N-ethyl perfluorooctane sulfonamido acetic acid (N-EtFOSAA), and 8:2 Fluorotelomer phosphate diester (8:2 diPAP), were also included in the PFAS mixture for adsorption tests. Moreover, two organic dyes, namely methylene blue (MB) and rose bengal (RB), were added into the PFAS mixture in adsorption experiments to facilitate selection of the optimal CTAC/CEC ratio, and to examine the impacts of organic pollutants on PFAS adsorption. The adsorption performance, including removal efficiency and adsorption kinetics and isotherms, for short- and long-chain PFAS and their precursors was well examined. Lastly, the modified clay was compared with other commonly used adsorbents, such as GAC and PAC, in the aspects of adsorption performance and cost-effectiveness.

The information of chemical reagents used can be found in Table 1 below. The physicochemical properties of PFAS and precursors investigated in this study are shown in Table 2 below. Prior to quantification, samples collected in the adsorption experiments were subject to centrifugation at 14,000 g for 10 minutes. The PFAS and precursors in the supernatants were quantified by a 1290 Infinity II LC system coupled with a 6470 Triple Quad Mass Spectrometer (LC-MS/MS, Agilent Technologies, Santa Clara, CA, USA). Prior to quantification, samples were prepared following EPA Method 537.1 Revision 2.0 by spiking 13C4-PFOS and 13C2-PFOA as internal standards. Two Agilent Eclipse Plus C18 columns including a ZORBAX analytical column (3× 50 mm, 1.8 μm) and a delay column (4.6×50 mm, 3.5 μm) were employed with a working temperature of 50° C. A binary mobile phase with Solvent A and B of 5 mM ammonium acetate in water and 95% methanol, respectively, was used at a flow rate of 0.5 mL/min. The content of Solvent A in the mobile phase gradient profile originated from 70%, declined to 0% at 8 min, and kept for 4 min, followed by reverting to the initial value.

TABLE 1

| Substance | Grade/Purity | Supplier |
|---|---|---|
| Perfluorohexanoic acid | ≥98% | Frontier |
| | | Scientific |
| Perfluoroheptanoic acid | ≥98% | Matrix Scientific |
| Perfluorooctanoic acid | ≥96% | Sigma-Aldrich |
| Perfluorononanoic acid | ≥98% | Oakwood |
| | | Chemicals |
| Perfluorodecanoic acid | ≥98% | Matrix Scientific |
| Perfluoroundecanoic acid | ≥98% | Oakwood |
| | | Chemicals |
| Potassium perfluorobutanesulfonate | ≥98% | Accela |
| | | Chembio Inc |
| Perfluorohexanesulfonic acid | ≥98% | Frontier |
| potassium salt | | Scientific |
| Heptadecafluorooctanesulfonic acid | ≥98% | Sigma-Aldrich |
| potassium salt | | |
| Undecafluoro-2-methyl-3- | ≥97% | SynQuest |
| oxahexanoic acid | | Laboratories |
| 6:2 Fluorotelomer sulfonic acid | ≥98% | SynQuest |
| | | Laboratories |
| 2-N-ethyl perfluorooctane | ≥98% | SynQuest |
| sulfonamido acetic acid | | Laboratories |
| 8:2 Fluorotelomer phosphate diester | ≥98% | Wellington |
| | | Laboratories |
| | | Inc. |
| Perfluoro-n-[1,2-¹³C₂]octanoic acid | ≥98% | Wellington |
| | | Laboratories |
| | | Inc. |
| Sodium perfluoro-1[1,2,3,4- | ≥98% | Wellington |
| ¹³C₄]octanesulfonate | | Laboratories |
| | | Inc. |
| Perfluoro-n-[1,2,3,4,6-¹³C₅]hexanoic | ≥98% | Wellington |
| acid | | Laboratories |
| | | Inc. |
| Montmorillonite K10 | N/A | Alfa Aesar |
| Cetyltrimethyl ammonium chloride | ≥95% | Tokyo Chemical |
| | | Industry |
| Ammonium acetate | LC/MS | Fisher Scientific |
| | Grade | |
| Methanol | LC/MS | Fisher Scientific |
| | Grade | |
| Water | LC/MS | Fisher Scientific |
| | Grade | |
| Sodium hydroxide | Certified | Fisher Scientific |
| | ACS | |
| Sodium carbonate anhydrous | Certified | Fisher Scientific |
| | ACS | |
| Tetrabutylammonium | Certified | ACROS |
| hydrogensulfate | ACS | Organics |
| tert-butyl methyl ether | Certified | ACROS |
| | ACS | Organics |
| Methylene blue | N/A | ACROS |
| | | Organics |
| Rose bengal | 85% | ACROS |
| | | Organics |

Table 2 displays the physicochemical properties of PFAS and precursors investigated in this study (Sw: solubility in water, g/L; pKa: dissociation constant).

TABLE 2

| | | | Molecular | | |
|---|---|---|---|---|---|
| | | Chemical | weight | S_{w} | pKₐ |
| Compound | Abbreviation | formula | (g/mol) | (25° C.) | (25° C.) |
| Perfluorohexanoic | PFHxA | C₆HF₁₁O₂ | 314 | 15.7 ^{a} | −0.16 ^{e} |
| acid | | | | | |
| Perfluoroheptanoic | PFHpA | C₇HF₁₃O₂ | 364 | 3.65 × 10^{-3 b} | −2.29 ^{b} |
| acid | | | | | |
| Perfluorooctanoic | PFOA | C₈HF₁₅O₂ | 414 | 3.4 ^{a} | −0.2 ^{e} |
| acid | | | | | |
| Perfluorononanoic | PFNA | C₉HF₁₇O₂ | 464 | 6.25 × 10⁻² ^{b} | −0.21 ^{b} |
| acid | | | | | |
| Perfluorodecanoic | PFDA | C₁₀HF₁₉O₂ | 514 | 9.5 ^{c} | −5.2 ^{f} |
| acid | | | | | |
| Perfluoroundecanoic | PFUnA | C₁₁HF₂₁O₂ | 564 | 4 × 10⁻³ ^{c} | −5.2 ^{f} |
| acid | | | | | |
| Potassium | PFBS | C₄F₉O₃SK | 338 | 46.2 ^{d} | 0.14 ^{e} |
| perfluorobutanesulfonate | | | | | |
| Perfluorohexanesulfonic | PFHxS | C₆F₁₃KO₃SK | 438 | 2.3 ^{c} | 0.14 ^{e} |
| acid potassium salt | | | | | |
| Heptadecafluorooctanesulfonic | PFOS | C₈HF₁₇KO₃SK | 538 | 0.57 ^{a} | −3.27 ^{g} |
| acid potassium salt | | | | | |
| Undecafluoro-2-methyl-3- | GenX | C₆HF₁₁O₃ | 330 | N/A | 2.84 ^{f} |
| oxahexanoic acid | | | | | |
| 6:2 Fluorotelomer | 6:2 | C₈H₅F₁₃O₃S | 428 | 1.3 ^{c} | 1.31 ^{c} |
| sulfonic acid | FTSA | | | | |
| 2-N-ethyl | N-EtFOSAA | C₁₂H₈F₁₇NO₄S | 585 | N/A | N/A |
| perfluorooctane | | | | | |
| sulfonamido acetic | | | | | |
| acid | | | | | |
| 8:2 Fluorotelomer | 8:2 | C₂₀H₉F₃₄O₄P | 990 | N/A | N/A |
| phosphate diester | diPAP | | | | |

To create the novel compound, montmorillonite K10 with a cation exchange capacity (CEC) of 59 mmol/100 g was used for synthesis of cetyltrimethyl ammonium chloride (CTAC) modified clay. A two-step procedure was employed in the synthesis process, 100 g of K10 Mt was added to 1 L of 150 g/L Na₂CO₃ solution in a flask, and the mixture was stirred at 800 rpm at room temperature for 3 hours. Then a few drops of concentrated hydrochloric acid were added to the solution, followed by rinsing with deionized (DI) water for three times till no Cl— was detectable. The pellet was dried at 108° C. for overnight, which generated the solid of sodium montmorillonite (Na-Mt). Then 10 g of obtained Na-Mt was added to 200 mL of 10, 25, or 100 mmol/L solution of CTAC, and the mixtures were stirred at 800 rpm at 80° C. for 2 h, followed by rinsing with DI water for three times and drying at 108° C. for 10 h. Consequently, the process generated three modified clays with different ratios of CTAC/CEC, i.e., 0.34, 0.85, and 3.39, which were referred to Mt-CTAC_{0.34}, Mt-CTAC_{0.85}, and Mt-CTAC_{3.39}, respectively.

The morphological and compositional analyses of the unmodified (Na-Mt) and CTAC modified clays were performed by a scanning electron microscopy equipped with energy dispersive X-ray spectroscopy (SEM-EDS, Zeiss LEO 1550, Oberkochen, Germany; Bruker Quantax XFlash 6, Billerica, MA, USA). A Rigaku MiniFlex 6G benchtop powder X-ray diffractometer (XRD, Rigaku Corporation, Tokyo, Japan) equipped with graphite monochromator and D/teX Ultra one-dimensional silicon strip detector was used to examine the crystal structure of clays using Cu-Kα radiation. The crystalline samples under investigation were ground and placed in zero-background holders, which were scanned at a step of 0.01°.

The Brunauer-Emmett-Teller (BET) method was used to determine the surface area and pore volume of the adsorbents. A 3Flex gas adsorption analyzer (Micromeritics, Norcross, GA, USA) was applied to perform gas adsorption analysis. Three activation temperature, i.e., room temperature, 100° C., and 200° C., was employed to activate the samples for 24 h before gas adsorption analysis, during which the adsorbents were attached to the gas sorption analyzer, evacuated to 0.001 mbar, and cooled to −196° C., followed by analyzing with pure N₂ gas (≥99.999%, Airgas, Radnor, PA, USA).

The zeta potential at different pH was measured to quantify surface charge of the adsorbents using a Malvern Zetasizer Nano-ZS analyzer (Malvern Panalytical Ltd, Malvern, UK). A 100 mg of adsorbents were added into 20 mL of DI water and mixed well, and zeta potential at the original pH was determined. Subsequently, the pH of the mixture was adjusted in the range of 0 to 12 using either 0.1 M NaOH or 0.1 M HCl, followed by redetermination of zeta potential at each adjusted pH. The pH of point of zero charge (pHPZC) was determined as the pH at which zeta potential was equal to 0.

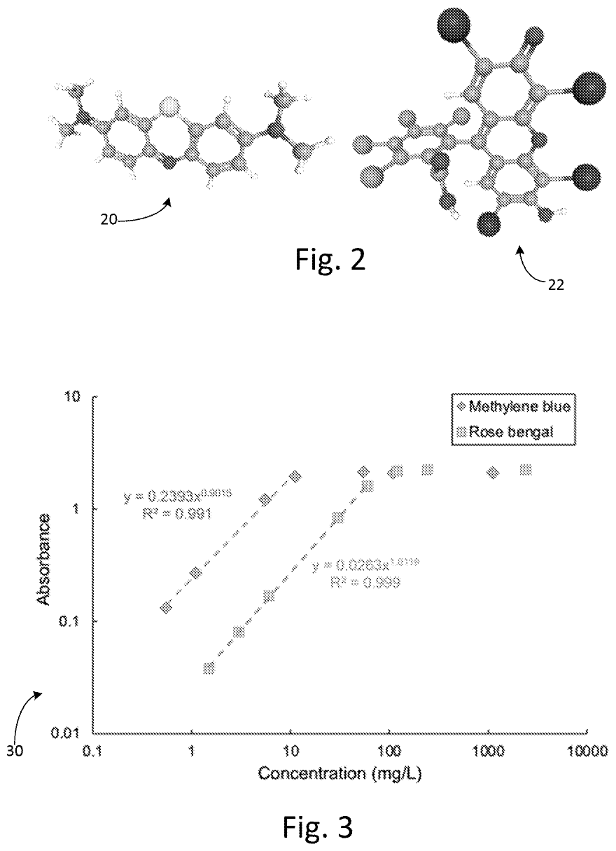

All adsorption experiments were performed in a batch mode and in triplicate using the Falcon 50-mL or 225-mL polypropylene (PP) centrifuge tubes (Corning Inc., Corning, NY, USA). The tubes were shaken at 150 rpm at room temperature during the whole adsorption process. A co-exposure adsorption test with a mixture of the ten PFAS (Table 1) and one of two organic dyes, either MB or RB, were used to evaluate adsorption performance of Na-MT and the three modified MT with different CTAC loadings, i.e., Mt-CTAC_{0.34}, Mt-CTAC_{0.85}, and Mt-CTAC_{3.39}. FIG. 2 is 3D conformers of methylene blue 20 and rose bengal 22 molecules. The initial concentrations were 10 mg/L for MB, 30 mg/L for RB, and 10 parts per billion (ppb) for each PFAS. The dosage of adsorbents was 2,500 mg/L in the co-exposure adsorption test. Samples were collected and analyzed for PFAS and dye concentrations at five time points, i.e., 0, 4, 8, 12, and 24 hours. The modified MT with the optimal CTAC/CEC ratio was selected and tested in the subsequent adsorption experiments.

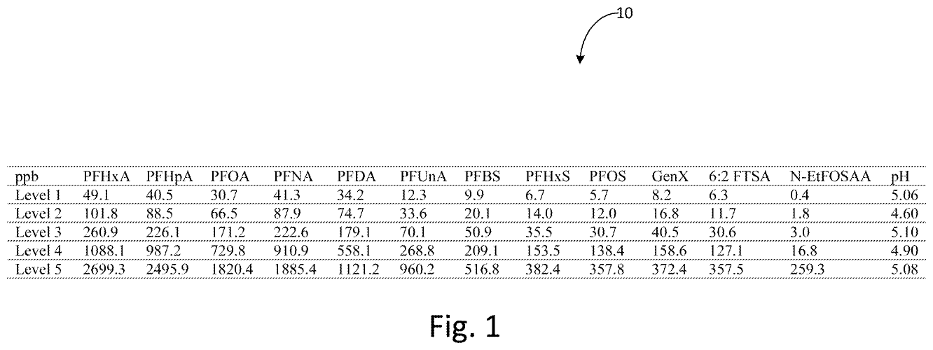

The adsorption kinetics and isotherms of the optimal modified clay was assessed using mixtures consisting of the ten PFAS and two precursors (6:2 FTSA and N-EtFOSAA). Five concentration levels of PFAS and precursors mixtures, which were from the lowest Level 1 to the highest Level 5, were prepared in DI water without pH adjustment. The initial pH and concentrations of each PFAS and precursor (C0) at each level of mixtures were quantified at t=0, which were shown in FIG. 1.

FIG. 1 is a table 10 of the initial pH and concentrations of each PFAS and precursor (C₀, ppb) at each level of mixtures in adsorption kinetics and isotherms experiments. The dosage of the tested adsorbent was 100 mg/L. Contact times of 1, 2, 4, 8, 12, and 24 hours were designed in the experiments. Additionally, the comparison of adsorption performance among the optimal modified clay, Na-Mt, and three widely applied adsorbents, i.e., FILTRASORBR 400 GAC and a PAC (Calgon Carbon, Pittsburgh, PA, USA), and a commercially available AC/AL-Clay based adsorbent, were evaluated using a mixture consisting of the ten PFAS and three precursors (Table 1) with an initial concentration of 10 ppb for each compound. Adsorption contacting times were set as 4, 24, and 48 hours.

The adsorbed PFAS and precursors per unit mass of adsorbents was determined as their mass difference between the blank controls (without adsorbents) and test groups with the same contact time, divided by the mass of adsorbents added. The removal efficiencies (%) of PFAS, precursors, or dyes were calculated as their concentrations in test groups divided by those in the blank controls with the same contact time. The adsorption data were fitted by three isotherm models, i.e., Langmuir, Freundlich, and Sips, given by Equations (1)-(3), respectively:

$$a . Langmuir \text{:} {q}_{e} = {q}_{m} \times {K}_{L} \times {C}_{e} / ( 1 + {K}_{L} \times {C}_{e} )$$

$$b . Freundlich \text{:} {q}_{e} = {K}_{F} \times {C}_{e}^{1 / n}$$

$$c . Sips \text{:} {q}_{e} = {q}_{m} \times {( {K}_{S} \times {C}_{e} )}^{1 / t} / [ 1 + {( {K}_{S} \times {C}_{e} )}^{1 / t} ]$$

where qₑ (mg/g) is the amount of adsorbate in solid phase at equilibrium, Cₑ (μg/L; ppb) is the concentration of adsorbate in aqueous phase at equilibrium, qₘ (mg/g) is the theoretical adsorption capacity, K_{L} (L/μg) is the Langmuir constant, K_{F} (mg·L^{1/n}/(g·μg^{1/n})) is the Freundlich constant related to adsorption capacity and energy, n is the dimensionless heterogeneity coefficient indicating the favorability of the adsorption process, K_{S} (L/μg) is the Sips constant associated with adsorption affinity, and t is a dimensionless parameter qualitatively characterizing the heterogeneity of the adsorbate-adsorbent system.

The adsorption performance was compared for unmodified and modified clays with co-exposure to PFAS and organic dyes. The amount of surfactant loading in the modified clays may exert impacts on the distribution of surfactant cations/molecules within the MT space and the surfactant-MT interactions, thus leading to different adsorption performance. Three CTAC loadings were investigated, i.e., low, medium, and high CTAC/CEC ratios of 0.34, 0.85, and 3.39, respectively, and an optimal ratio was selected based on the adsorption performance. To facilitate the screening process, a co-exposure adsorption method was used by mixing a cationic dye MB 20 or an anionic dye RB 22 with PFAS in the aqueous solution, since the dye colors can be easily monitored and serve as an indicator for adsorption performance. Moreover, with the existence of organic dyes, the adsorption performance of modified clays for organic pollutants and their impacts on PFAS adsorption can be evaluated. To quantify the concentrations of dyes simply by the UV-visible spectroscopy, the calibration curves between the concentrations and absorbance at 662 and 564 nm were developed for MB and RB, respectively, as shown in FIG. 3. FIG. 3 is a graph 30 illustrating the calibration curves between the concentrations and absorbance at 662 and 564 nm for methylene blue 20 and rose Bengal 22, respectively. The initial concentrations of MB and RB, which were 10 and 30 mg/L, respectively, fell in the linear ranges of the calibration curves.

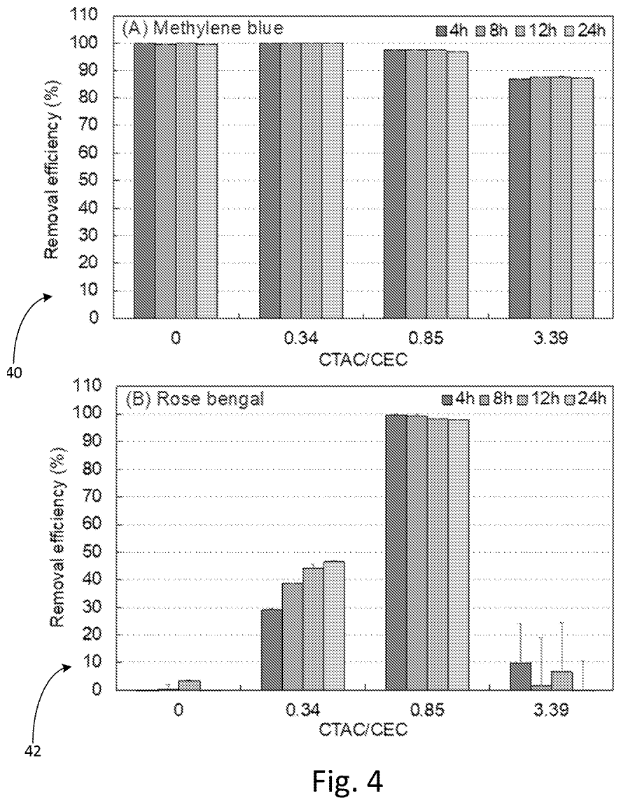

The removal of MB 20 and RB 22 with co-existence of PFAS by Na-Mt and the three modified clays, i.e., MT-CTAC_{0.34}, MT-CTAC_{0.85}, and MT-CTAC_{3.39}, during contacting times of 4, 8, 12, and 24 hours was shown in FIG. 4. FIG. 4 is graphs 40 and 42 illustrating the adsorption (removal efficiency) of methylene blue 20 and rose bengal 22 by the unmodified (Na-MT) and three modified clays (MT-CTAC_{0.34}, MT-CTAC_{0.85}, and MT-CTAC_{3.39}) with co-existence of PFAS. Error bars represent the standard deviation of triplicate measurements.

The results show that the adsorption processes of MB by all four examined clays reached equilibrium within 4 hours. The CTAC loading exhibited a negative impact on adsorption of MB 20, with Na-MT and MT-CTAC_{0.34} showing the highest MB 20 removal efficiency of nearly 100%, followed by MT-CTAC_{0.85} and MT-CTAC_{3.39} exhibiting approximately 97% and 87% removal efficiency, respectively. These findings could be attributed to that MB 20 is a cationic dye with positive charge, and the major mechanism of its adsorption by Na-MT and MT-CTAC_{0.34} was the cation exchange of MB+ with Na+. While for MT-CTAC_{0.85} and MT-CTAC_{3.39}, in which Na+ had been largely or fully exchanged, hydrophobic interactions mainly contributed to adsorption of the hydrophobic MB 20. In contrast, CTAC/CEC ratios affected RB 22 adsorption positively in the range of 0-0.85, showing that Mt-CTAC_{0.85} adsorbed nearly 100% of RB 22 within 4 hours while Na-MT had almost no adsorption. However, the positive impact of CTAC loadings was not applicable to Mt-CTAC_{3.39}, which adsorbed RB 22 weakly with a removal efficiency of <10%. The extremely low adsorption of RB 22 by Na-MT might be due to electrostatic repulsion between negatively charged clay surface and RB molecules. With the increase of CTAC loadings, hydrophobic interactions started to play a role in adsorption of the hydrophobic RB 22. However, the large molecular dimensions of RB 22 with a benzene and a xanthene moiety, as well as the severe blocking of the Mt interlamellar space caused by the large intercalated CTA+ cations at CTAC/CEC of 3.39, can inhibit the attachment of RB molecules onto the interlayer spacing of MT.

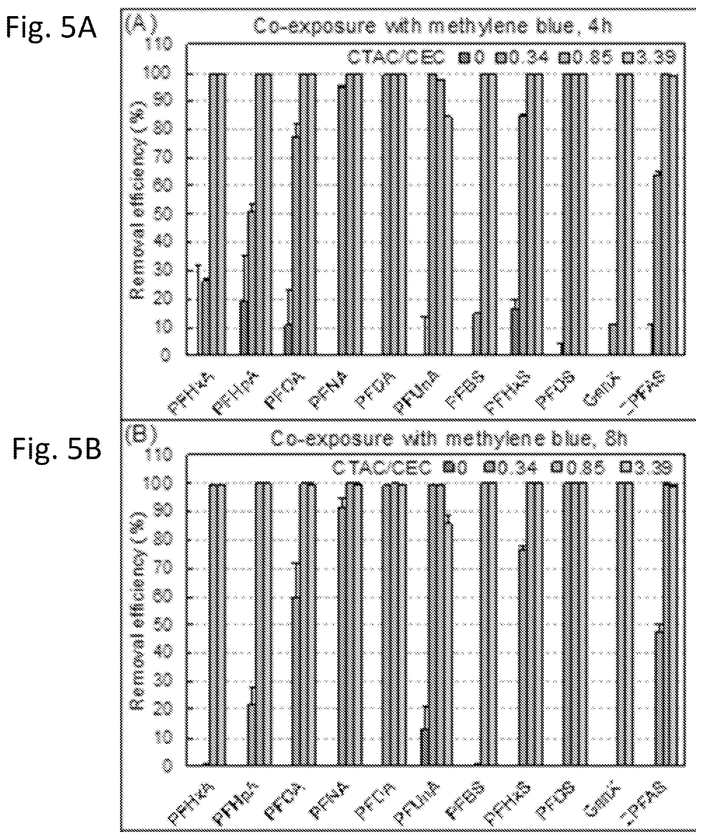

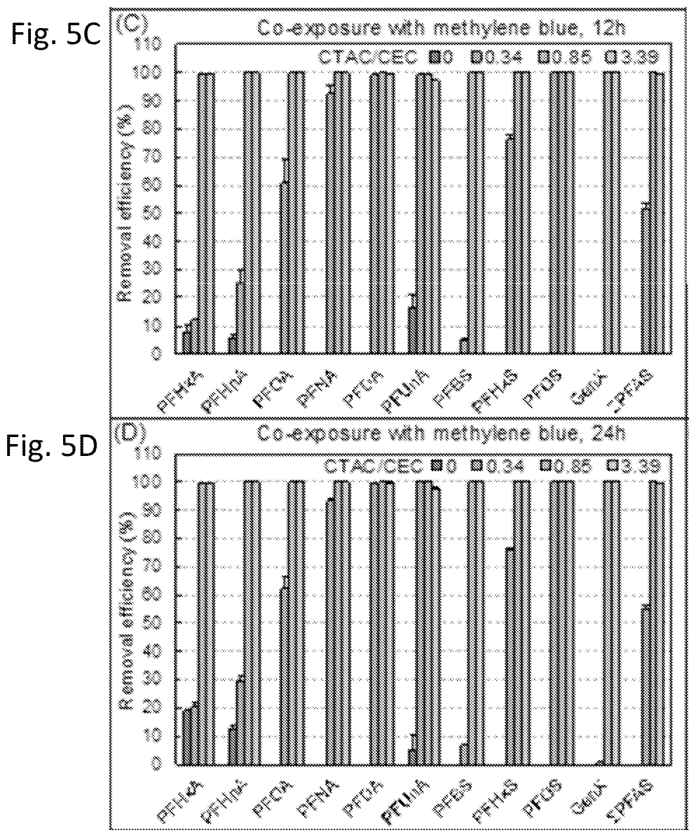

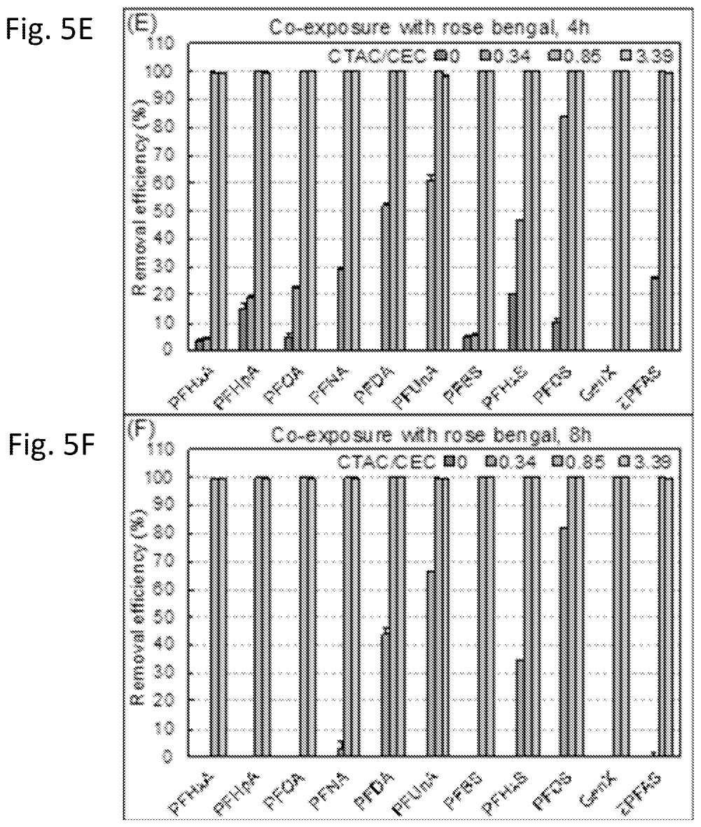

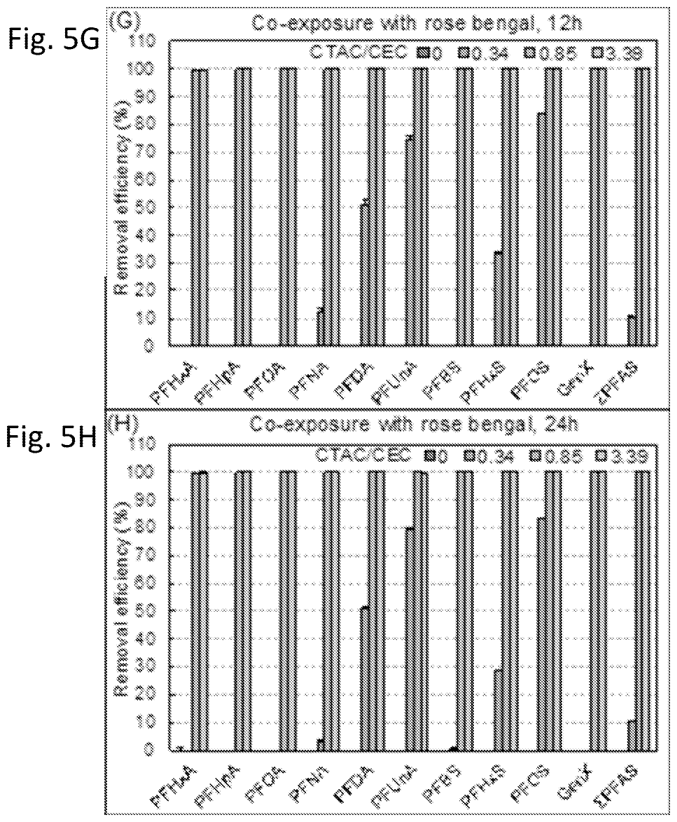

The PFAS adsorption by the four clays with the co-existence of MB or RB was also evaluated as shown in FIGS. 5A-5H. FIGS. 5A-5H are graphs illustrating the adsorption of PFAS and precursors by the unmodified (Na-MT) and three modified clays (MT-CTAC_{0.34}, Mt-CTAC_{0.85}, and Mt-CTAC_{3.39}) with co-exposure of the organic dye (methylene blue 20 or rose bengal 22). Error bars represent the standard deviation of triplicate measurements. Results showed CTAC loadings had a positive impact on PFAS adsorption, with MT-CTAC_{0.85} and Mt-CTAC_{3.39} adsorbing nearly 100% of PFAS and Na-MT showing extremely low adsorption. Specifically, Mt-CTAC_{0.85} displayed the best adsorption performance among the four clays, which removed 100% of almost all PFAS with co-existence of either MB or RB. The adsorption reached equilibrium within 4 hours, and no desorption was observed for longer contacting times. Interestingly, although the examined PFAS were also anionic because of the low pKa (Table 1), MT-CTAC_{3.39} exhibited a comparable adsorption capacity with MT-CTAC_{0.85} for almost all PFAS, which was different from the low adsorption of RB. This might be due to the linear structures and smaller molecular dimensions of PFAS than RB, which facilitated the entering of PFAS into the MT interlayer space. Similar to RB, negligible PFAS were adsorbed by Na-MT probably due to the electrostatic repulsing force. In comparison, the amounts of adsorbed PFAS by Mt-CTAC_{0.34} were dependent on carbon chain length with the higher PFAS adsorption for longer-chain PFCAs and PFSAs. Moreover, PFSAs were more easily to be adsorbed by MT-CTAC_{0.34} than PFCAs with the with the same chain length, which might be attributed to the lower water solubility (Table 2) and thus higher hydrophobicity of the former than the latter. This also highlighted the important role of hydrophobic interactions in the PFAS adsorption process. It can be also observed that MB, compared to RB, seemed promoted the adsorption of PFAS, which might be due to electrostatic interactions of cationic MB and anionic PFAS. From the findings related to the adsorption of organic dyes and PFAS, Mt-CTAC_{0.85} was chosen as the optimal modified clay and evaluated further.

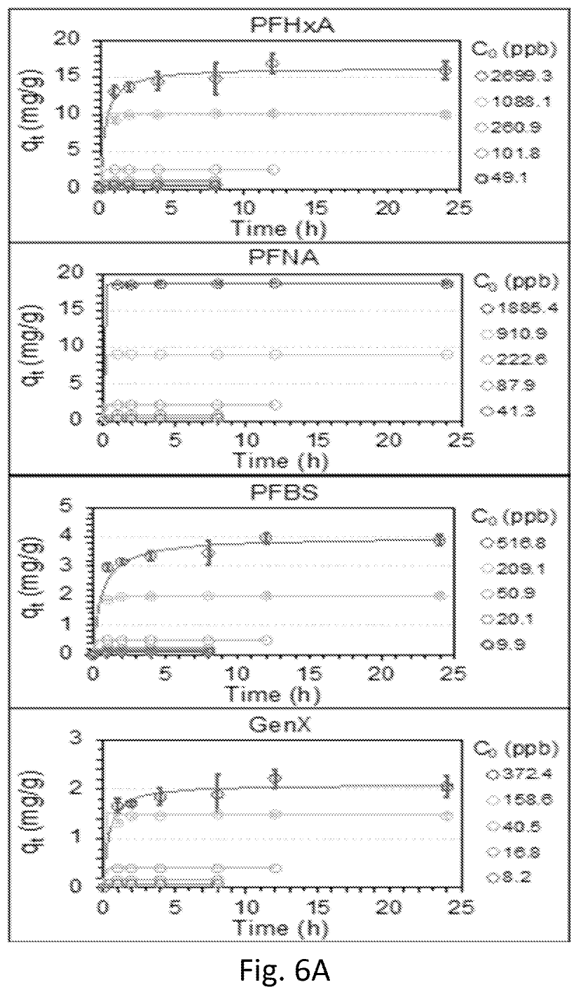

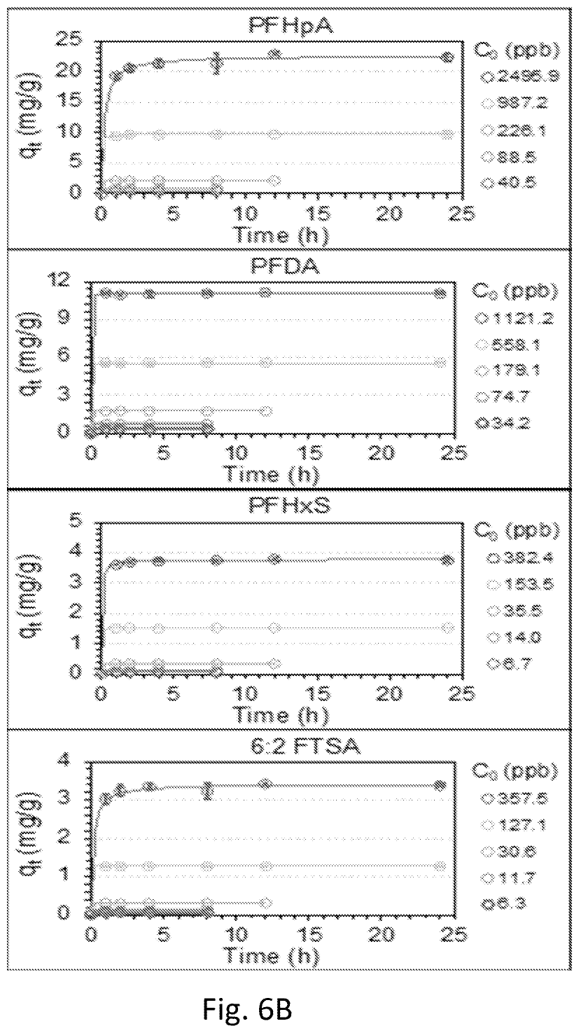

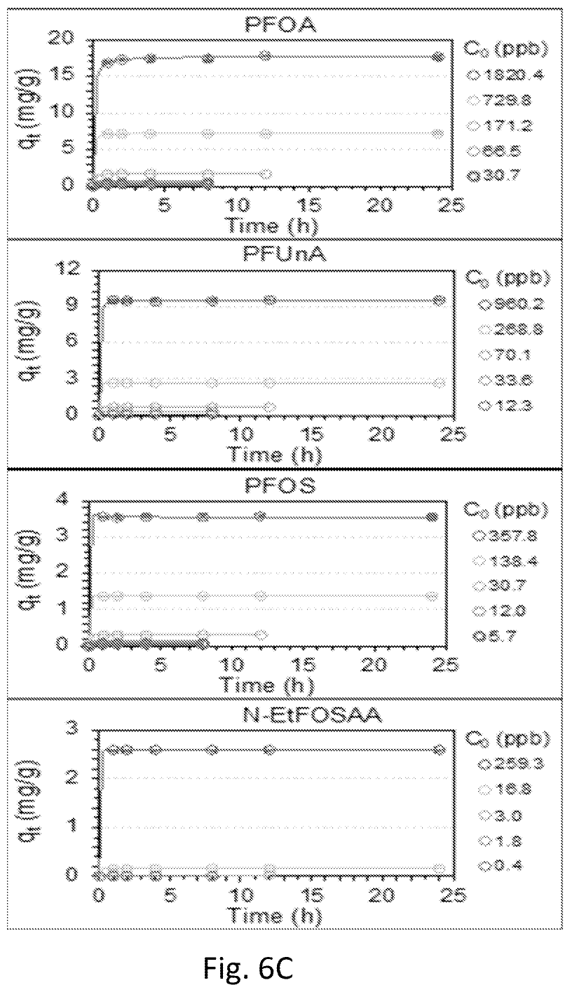

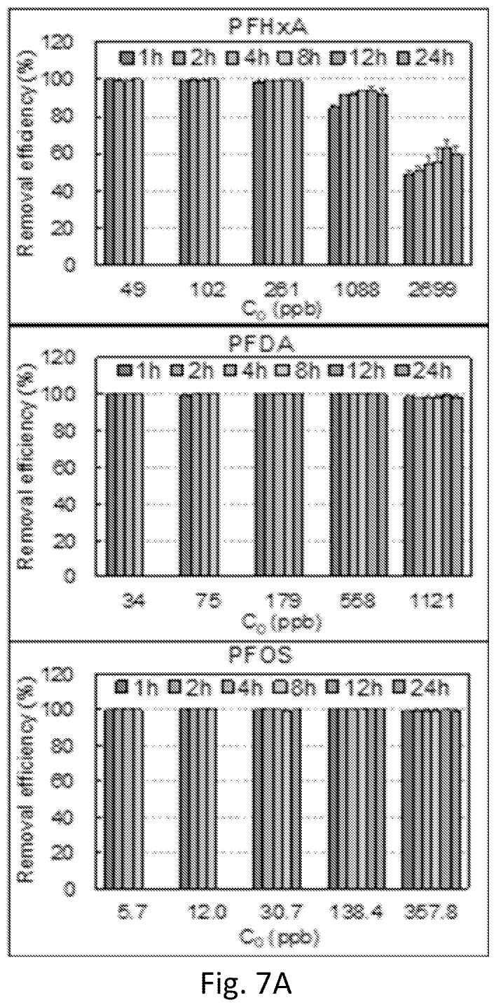

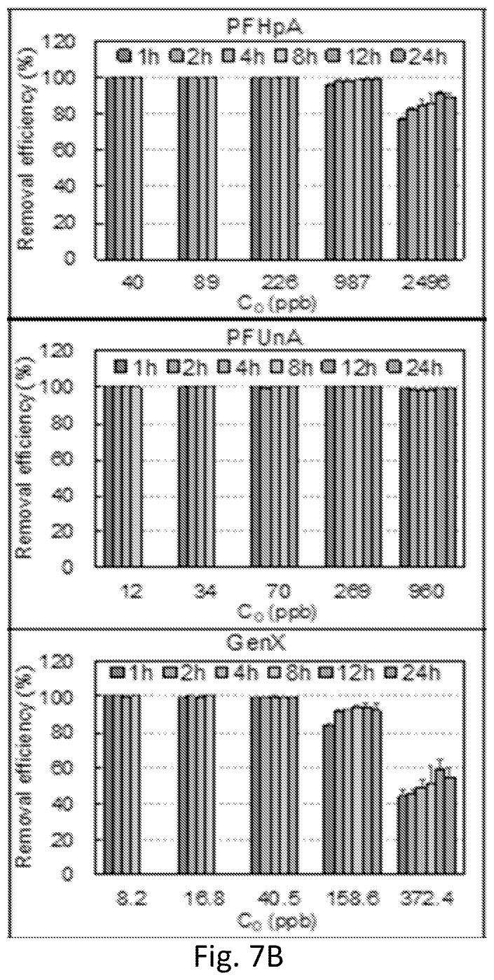

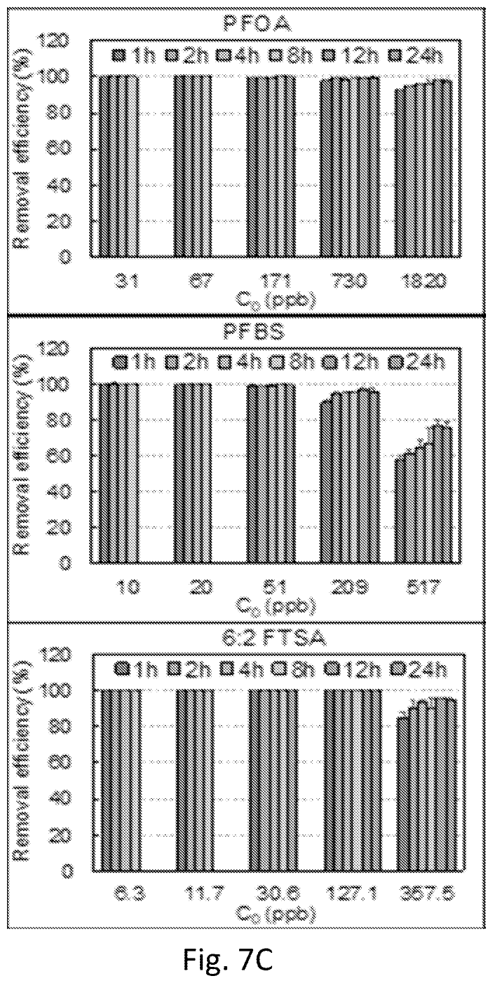

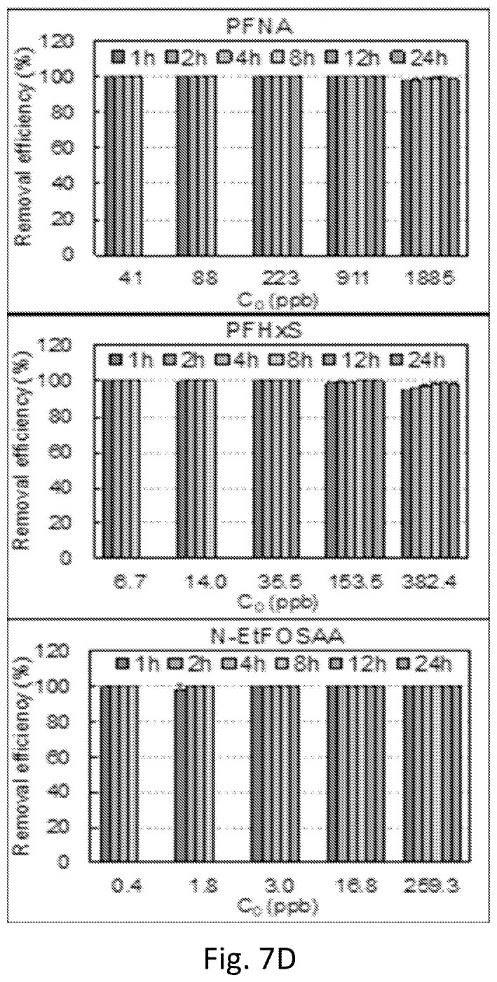

The selected optimal modified clay, MT-CTAC_{0.85}, was subject to exposure to aqueous solution mixtures of 12 PFAS and precursors with a series of five initial concentration levels (Table 1). The relations between contacting times and adsorbed amounts of PFAS and precursors are displayed in FIGS. 6A-6C. FIGS. 6A-6C are graphs illustrating the adsorption kinetics of PFAS and precursors at different initial concentrations for MT-CTAC_{0.85}. Error bars represent the standard deviation of triplicate measurements. Adsorption kinetics indicated that for all the 12 examined compounds, there was a fast adsorption process occurring within the first hour of contacting time. For the lower initial concentrations of Levels 1-3, the adsorption reached saturation within 1 h for all PFAS and precursors, and all removal efficiencies were 100%, as shown in FIGS. 7A-7D, indicating the expeditious kinetics and high adsorption capacity of Mt-CTAC_{0.85}. FIGS. 7A-7D are graphs illustrating the removal efficiency of PFAS and precursors at different initial concentrations and different contacting times (1, 2, 4, 8, 12, and 24 h) for MT-CTAC_{0.85}. Error bars represent the standard deviation of triplicate measurements.

Regarding the higher initial concentrations of Levels 4-5, an adsorption manner depended on carbon chain length can be observed, with the higher removal efficiency for the PFAS with the longer chain length. In detail, at the initial concentration of Level 4, for long-chain PFCAs and PFSAs (i.e., PFOA, PFNA, PFDA, PFUnA, PFHxS, and PFHxS), as well as the two long-chain precursors (i.e., 6:2 FTSA and N-EtFOSAA), a saturated adsorption with 100% removal efficiency was achieved within 1 hour and no desorption was observed. While within the same contacting time, short-chain PFCAs and PFSAs (i.e., PFHxA, PFHpA, and PFBS), as well as GenX, were not fully adsorbed, with removal efficiencies ranging from 84% to 96%. The adsorption process continued to occur with the increase of contacting time and reached equilibrium within 4 hours.

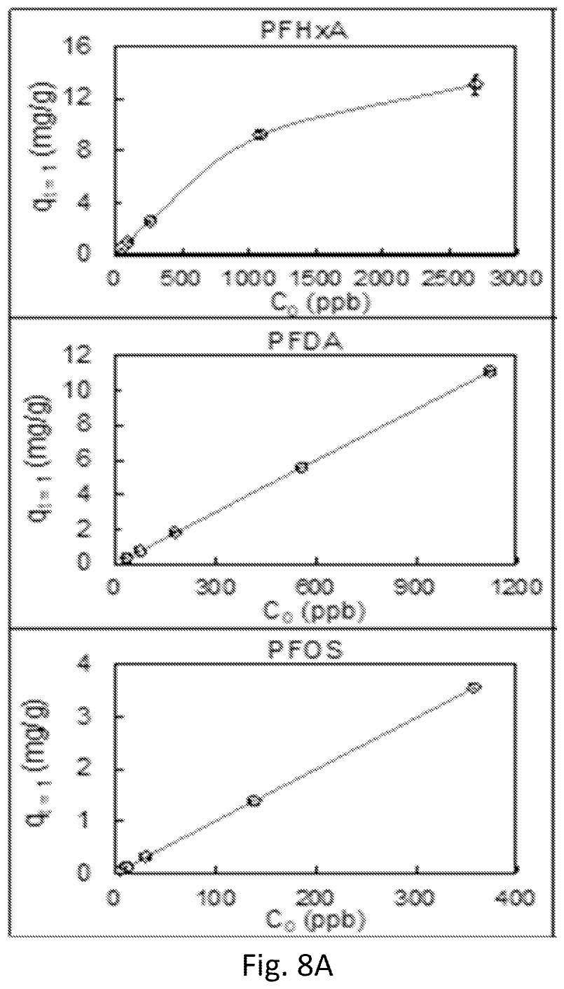

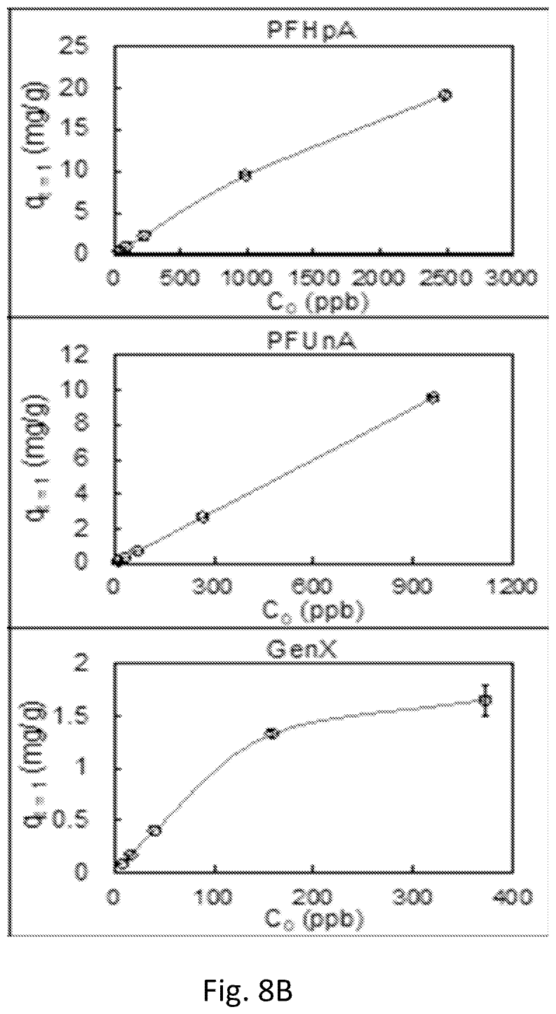

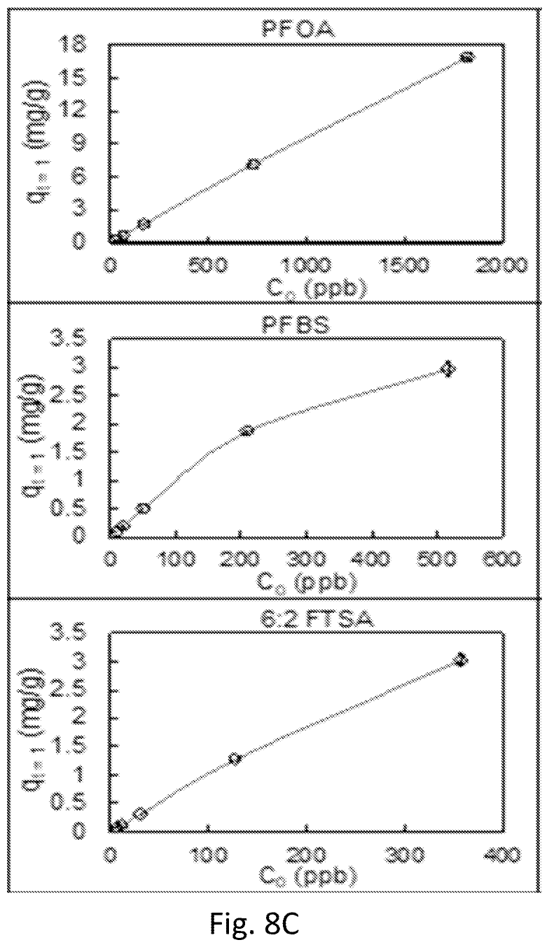

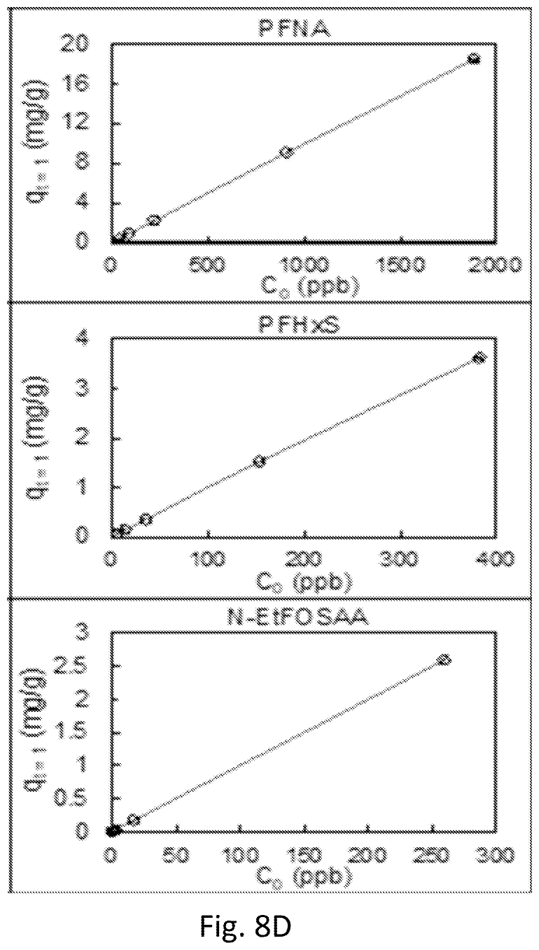

Consequently, the adsorption process can be divided into three phases. In the first phase, PFAS and precursors were rapidly attached onto the interlayers of modified clay, and the second phase was slower because of the electrostatic repulsive force, followed by the third phase of equilibrium. This similar multiple-phase adsorption process was also observed in the adsorption of 4-nitrophenol by modified clay. At the initial concentration of Level 5, a similar adsorption process with three phases was observed for short-chain PFAS, but with the lower removal efficiency and longer second phase than those at Level 4. In comparison, among the long-chain PFAS and precursors, PFOA, PFHxS, and 6:2 FTSA, which possess relatively shorter chain length, also exhibited unsaturated adsorption within 1 hour. Additionally, the linear relationship between initial concentrations and adsorbed amounts at t=1 h for long-chain PFAS and precursors, as well as nonlinear curves for short-chain ones, shown in FIGS. 8A-8D, which indicates saturated and unsaturated adsorption, respectively, further demonstrated the impact of chain length on adsorption. FIGS. 8A-8D are graphs illustrating the relationship between initial concentrations (C₀) and mass of PFAS and precursors adsorbed by MT-CTAC_{0.85} att=1 h (qₜ=1).

Due to the excellent adsorption capacity of Mt-CTAC_{0.85}, the adsorbate concentrations in the aqueous phase were negligible, especially at the lower concentration levels and for long-chain PFAS and precursors, therefore it was not feasible to obtain Ce values for fitting isotherm models for individual compound. Moreover, a similar adsorption mechanism might be shared by all the examined PFAS and precursors due to their comparable physicochemical properties. Thus, the total qe and Ce values of all PFAS and precursors were calculated and employed for establishing isotherm models. Three common isotherm models, namely Langmuir, Freundlich, and Sips, were used to fit experimental adsorption data. Langmuir isotherm was designed mainly for gas-solid phase adsorption, but it is also applied in describing adsorption processes in various adsorbate-adsorbent systems. Freundlich isotherm predicts adsorption processes occurring on heterogonous surfaces by involving the surface heterogeneity and the exponential distribution of active adsorption sites and their energy. In comparison, Sips isotherm is a combination of Langmuir and Freundlich targeting for prediction of adsorption in heterogeneous systems and overcoming limitations of the rising adsorbate concentration related to the Freundlich model. It reduces to Freundlich isotherm at low adsorbate concentrations, while it predicts a monolayer adsorption in a similar manner as Langmuir model at high adsorbate concentrations. It appears that there was a preference for the formation of a monolayer on the aqueous clay surface for PFAS molecules at the high concentration, and adsorption of PFOS and PFOA onto ferrihydrite and PFOS onto goethite also exhibited monolayer formation.

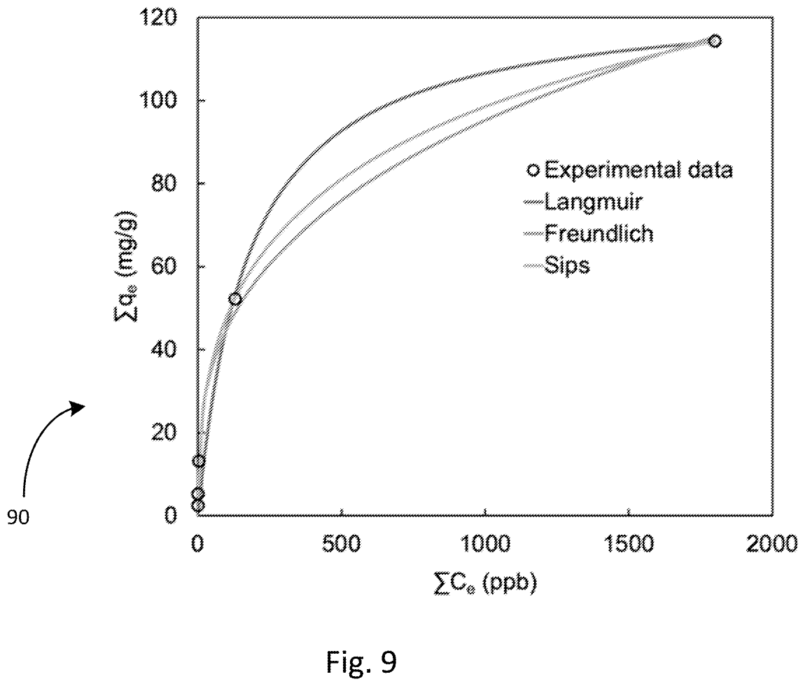

FIG. 9 is a graph 90 illustrating adsorption isotherms of total PFAS and precursors for MT-CTAC_{0.85}, plotted with Langmuir, Freundlich, and Sips models. As shown, experimental data represent the mean values of triplicate measurements. Langmuir model fitted the experimental adsorption data very well at the high concentration range and Freundlich isotherm fitted excellently at the low concentration range, while Sips isotherm fitted the data best overall with the highest correlation (Table 3). As shown in Table 4, at low concentrations the modeled qe values by Sips isotherm were closer to those predicted by Freundlich, while at high concentrations the qe values predicted by Sips were closer to those generated from Langmuir, indicating the successful application of Sips isotherm in the prediction of the adsorption process. Moreover, the adsorption capacity of Mt-CTAC_{0.85} was predicted to be 255.27 mg/g by the Sips model (Table 3).

Table 3 below illustrates the parameters and values derived from adsorption isotherm models of Langmuir, Freundlich, and Sips in adsorption processes of MT-CTAC_{0.85}.

TABLE 3

| Model | Parameter | Value |
|---|---|---|
| Langmuir | R² | 0.9850 |
| | K_{L} (L/μg) | 5.709 × 10⁻³ |
| | qₘ (mg/g) | 125.22 |
| Freundlich | R² | 0.9966 |
| | K_{F} (mg · L^{1/n}/(g · μg^{1/n})) | 10.028 |
| | n | 3.070 |
| Sips | R² | 0.9998 |
| | K_{S} (L/μg) | 3.427 × 10⁻⁴ |
| | qₘ (mg/g) | 255.27 |
| | t | 2.302 |

Table 4 below illustrates the experimental and isotherm modeled values of total adsorbed PFAS and precursors at equilibrium for their different concentrations in aqueous phase at equilibrium in adsorption processes of MT-CTAC0.85.

TABLE 4

| | ΣPFAS qₑ | |
|---|---|---|
| ΣPFAS Cₑ | experimental | ΣPFAS qₑ modeled (mg/g) |

| (ppb) | (mg/g) | Langmuir | Freundlich | Sips |
|---|---|---|---|---|
| 0.17 | 2.45 | 0.12 | 5.63 | 3.64 |
| 0.44 | 5.29 | 0.31 | 7.65 | 5.44 |
| 3.06 | 13.18 | 2.15 | 14.44 | 12.35 |
| 128.79 | 52.17 | 53.06 | 48.82 | 52.32 |
| 1798.93 | 114.30 | 114.11 | 115.25 | 114.27 |

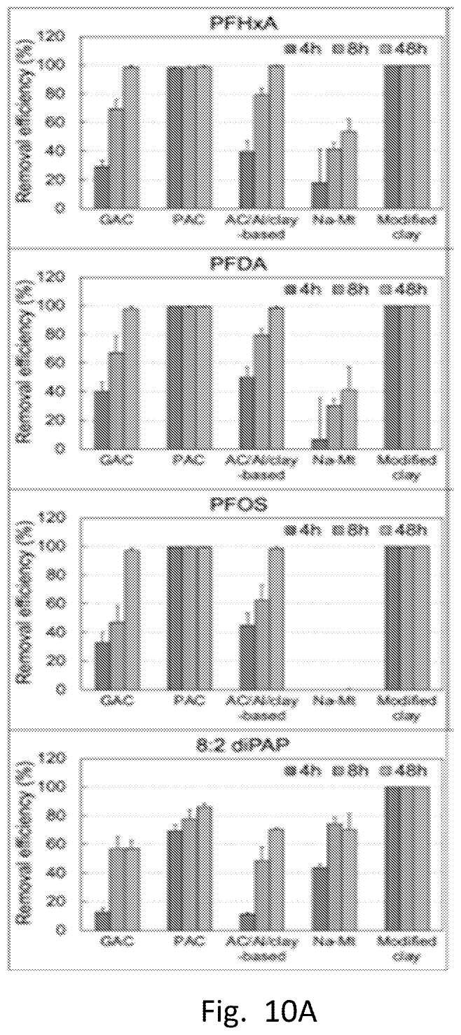

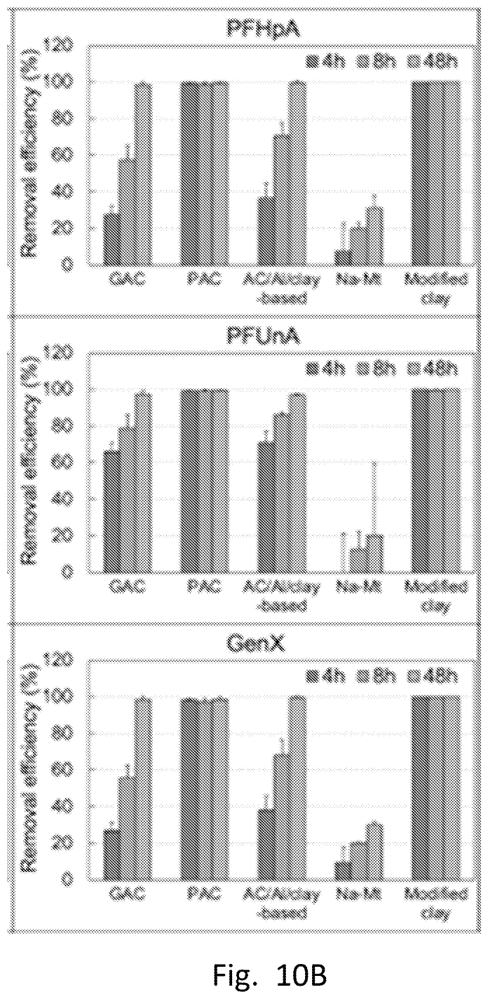

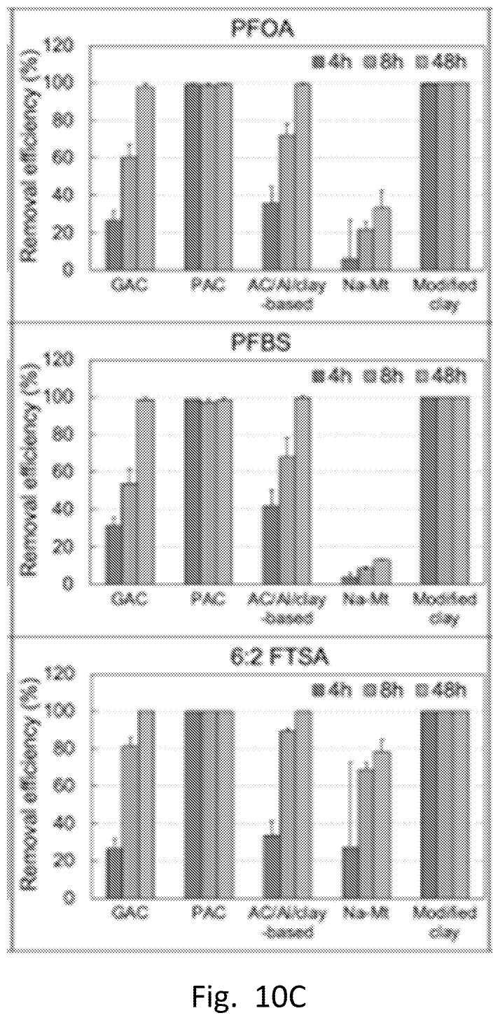

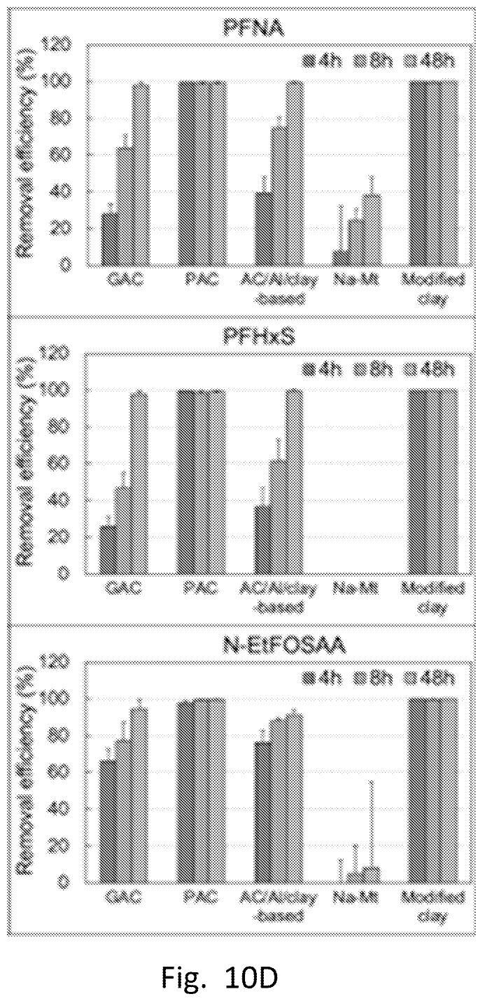

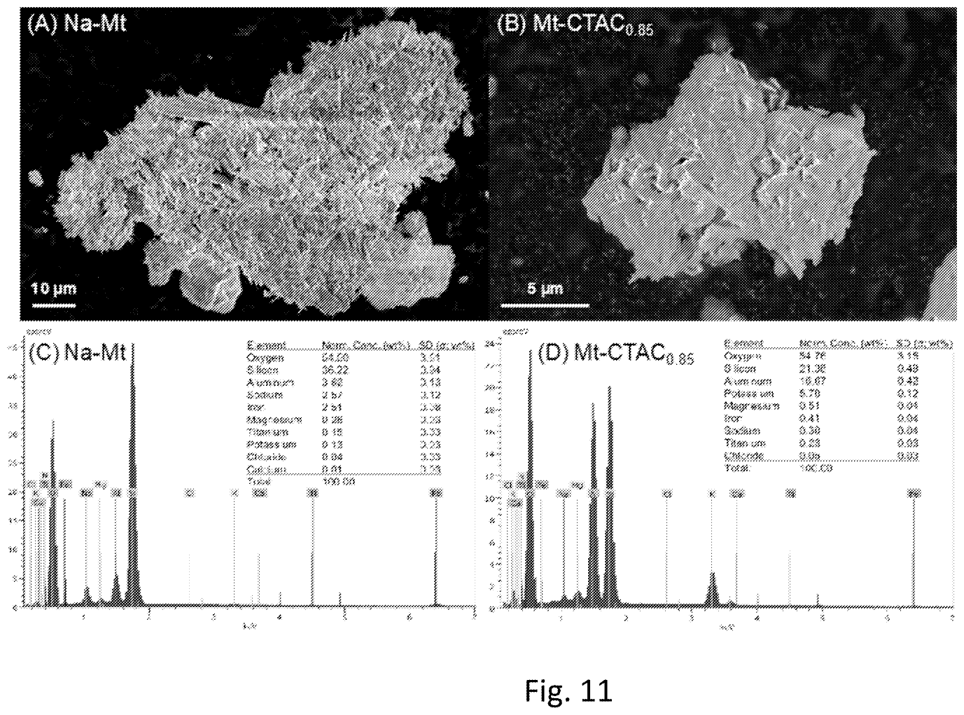

FIGS. 10a-10D are graphs illustrating Adsorption performance comparison among Na-Mt, Mt-CTAC_{0.85}, and other adsorbents FILTRASORB® 400 GAC, PAC, and a commercial AC/Al/clay-based based sorbent for PFAS and precursors at different contacting times (4, 8, and 48 h). Error bars represent the standard deviation of triplicate measurements. As shown in FIGS. 10A-10D, compared to GAC and PAC from Calgon, a commercial AC/Al/clay-based based sorbent, the modified clay demonstrated the highest removal of the ten PFAS and three precursors. Although not visible on the graphs, the removal by modified clay was fast and significantly higher than those of PAC. After four hours, the concentrations of all PFAS approached zero in the tested systems. For those with PAC, however, PFAS at the low end of ppt were still there. Additionally, the modified clay was highly efficient for adsorbing one PFAS precursor, 8:2 diPAP, for which the PAC was not highly effective.

A commercial adsorbent, FLUORO-SORB®, also a modified clay has been shown to have high efficiency in removing PFAS in contaminated water. Batch adsorption experiments were carried out with various adsorbents: FLUORO-SORB® 200, ion exchange resin, GAC (re-agglomerated bituminous type), and hardwood-based biochar. Adsorbent dosage was 12.5, 50, or 100 mg/L with adsorption time of 168 hours (7 days). The adsorption of PFAS by FLUORO-SORB® 200 was rapid in the first 12 hours and then slowed down until the equilibrium was achieved no later than 168 hhours. The modified MT K10 herein clay showed that at t=48 h, the concentrations of most PFAS in the liquid phase were less than 100 ppt, and most of PFAS were non-detectable. For FILTRASORB® 200, at t=48 h, most of PFAS in the liquid phase were still at a relatively high level. For example, at 48 h PFOA was ˜2 ppb (C0=6 ppb), and PFOS was also ˜2 ppb (C0=15 ppb) (Table 5). Compared to the removal efficiency for FLUORO-SORB, the modified MT K10 herein has much better performance in removal.

A preliminary cost analysis indicates that the modified MT K10 clay costs to produce, currently, around $0.75/kg. There is not likely to be a high-energy cost since the synthesis process necessitates 80-100° C., much lower than what is required to make GAC (400-800° C.). For comparison, the selling price of FILTRASORBR 400 GAC is $5.77/kg and for matCARETM, it is $26/kg (Table 4). Synthetic AC costs about $1.5/kg (Table 6).

Accordingly, the advantages of the modified MT K10 clay are that it is low-cost, and highly effective for removing different PFAS from contaminated water, has superior adsorption performance, and is much less costly overall. It also has much faster kinetics, shorter contacting time, significantly lower greenhouse emissions in production, and is overall cleaner technology than the extant art.

Table 5 illustrates adsorption performance of carbon- and clay-based adsorbents a reported in various publications.

TABLE 5

| | Dosage | | C₀ | Capacity | |
|---|---|---|---|---|---|
| Adsorbent | (mg/L) | PFAS | (ppm) | (mg/g) | Reference |
| FILTRASORB ® | 200 | PFOA | 0.5 | 2.52 | (Zhi and |
| 400 GAC | | PFOS | 0.5 | 2.59 | Liu 2015) |
| BPL PAC | 200 | PFOA | 0.5 | 2.49 | (Zhi and |
| | | PFOS | 0.5 | 2.48 | Liu 2015) |
| matCARE ™ | 10,000 | PFOS | 215 | 50 | (Das, |
| | | | | | Arias E et |
| | | | | | al. 2013) |
| Modified | 50 | PFOA | 5 | 207 ^{a} | (Wang, |
| clay | | PFOS | 5 | 403 ^{a} | Orr et |
| | | | | | al. 2021) |
| Modified | N/A | PFOA | 95 | ~62 ^{b} | (Zhou, |
| clay | | PFOS | 124 | ~339 ^{b} | Deng et |
| | | | | | al. 2010) |

For notation to Table 5: a: the highest values obtained by isotherm models; b: estimation from the figure in the reference for the modified clay with HDTMAB/CEC of 0.5. The mass of PFAS was calculated using the molecular weight in Table 1.

Table 6 is a comparison of current market prices among different adsorbents.

TABLE 6

| Adsorbent | Market price ($/kg) |
|---|---|
| Non-activated biochar | 0.246 ^{a} |
| Synthetic AC | 1.5 ^{a} |
| FILTRASORB ® 400 GAC | 5.77 ^{b} |
| Hydraffin CC8 × 30 GAC | 14.6 ^{b} |
| matCARE ™ | 26 ^{b} |
| Amberlite IRA 400 resin | 88 ^{b} |
| Amberlite XAD4 resin | 218 ^{b} |
| Modified clay (Mt-CTAC_{0.85}) in this study | 0.75 ^{c} |

The modified MT K10 clay was examined utilizing scanning electron microscopy (SEM)-energy dispersive spectroscopy (EDS) as shown in FIG. 11. FIG. 11 illustrates morphological (A, B) and compositional (C, D) analyses of Na-MT (A, C) and MT-CTAC_{0.85} (B, D) by SEM-EDS. Elemental compositions are shown with normalized concentrations (wt %) and standard deviations (SD). The elements not shown were undetectable, which were lower than the detection limit of 0.01 wt %. The MT K10 (B) demonstrates a smoother surface and smaller particle size after modification, with a porous and layered structure. As shown in FIG. 11 (D), the relative contents of Si, Fe, Na decreased after modification, while those of Al, K increased, due to pretreatment and reaction processes.

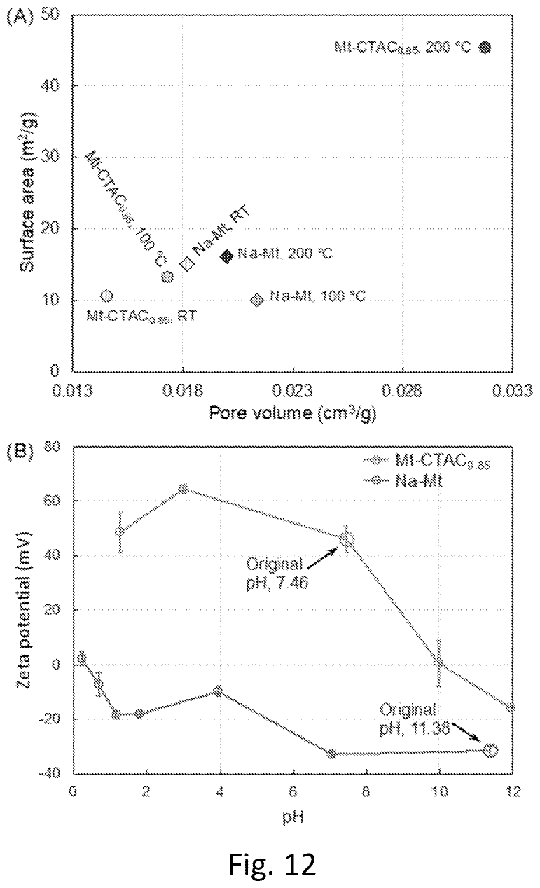

FIG. 12 is graphs illustrating (A) surface area and pore volume of Na-MT and MT-CTAC_{0.85} analyzed by BET, and (B) the relationship between zeta potential and pH for Na-Mt and Mt-CTAC_{0.85}. Error bars represent the standard deviation of triplicate measurements.

Terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A PFAS adsorbent compound, comprising:
montmorillonite (MT); and
at least cetyltrimethyl ammonium chloride (CTAC).

2. The compound of claim 1, wherein the montmorillonite is MT K10.

3. The compound of claim 2, wherein the MT K10 has a cation exchange capacity (CEC) of approximately 59 mmol/100 g.

4. The compound of claim 1, wherein the compound is combined in a ratio between MT-CTAC_{0.34} to MT-CTAC_{3.39}.

5. The compound of claim 1, wherein the compound in combined in a ratio of approximately MT-CTAC_{0.85}.

6. A PFAS adsorbent compound produced by the process of:
adding a predetermined amount of montmorillonite (MT) to a Na₂CO₃ solution;
stirring the MT-Na₂CO₃ solution for a predetermined duration;
drying the solution to form solid Na-MT;
adding the dried Na-MT to a predetermined solution of cetyltrimethyl ammonium chloride (CTAC);
stirring the Na-MT-CTAC solution for a predetermined duration to create a MT-CTAC compound; and
drying the MT-CTAC compound for a predetermined duration.

7. The PFAS adsorbent compound produced by the process of claim 6, further produced by the steps of:
adding concentrated hydrochloric acid (HCl) to a montmorillonite MT K10-Na₂CO₃ solution; and
rinsing the MT K10-Na₂CO₃ solution with deionized water until chloride (Cl—) is undetectable within the solution.

8. The PFAS adsorbent compound produced by the process of claim 7, wherein:
adding a predetermined amount of MT K10 to a Na₂CO₃ solution is adding 100 g of MTK10 per 1 L of 150 g/L Na₂CO₃; and
stirring the MT K10-Na₂CO₃ solution for a predetermined duration is stirring the solution for 3 hours; and
adding the dried Na-MT to a predetermined solution of CTAC is adding 10 g of dried Na-MT to 200 mL of CTAC that is in a concentration ranging from 10-100 mmol/L.

9. The PFAS adsorbent compound produced by the process of claim 6, wherein drying the MT-CTAC compound for a predetermined duration is drying the MT-CTAC compound at approximately 108° C. for at least 8 hours.

10. The PFAS adsorbent compound produced by the process of claim 7, wherein:
stirring the MT K10-Na₂CO₃ solution for a predetermined duration occurs at about 80° C.; and
drying the MT-CTAC compound for a predetermined duration occurs at about 108° C.

11. A method of removing PFAS from an aqueous solution, comprising:
combining montmorillonite (MT) and at least a cationic quaternary ammonium chloride (CTAC) to create a PFAS adsorbent compound (MT-CTAC); and
contacting the MT-CTAC with an aqueous solution containing PFAS to thereby remove at least a portion of the PFAS from the aqueous solution.

12. The method of claim 11, wherein the montmorillonite is MT K10 that has a cation exchange capacity (CEC) of approximately 59 mmol/100 g.

13. The method of claim 11, wherein the PFAS absorbent compound is combined in a ratio between MT-CTAC_{0.34} to MT-CTAC_{3.39}.

14. The method of claim 11, wherein contacting the MT-CTAC with an aqueous solution is contacting for a duration of 1 hour to 4 hours.

15. The method of claim 11, wherein:
the PFAS absorbent compound is combined in a ratio of Mt-CTAC_{0.85}; and
contacting the MT-CTAC with an aqueous solution is contacting for a duration of 1 hour.
